(19) United States
(12) Patent Application Publication
(10) Pub. No.: US 2020/0164912 A1
(43) Pub. Date: May 28, 2020

(54) APPARATUS FOR USE IN TURNING STEERABLE VEHICLE WHEELS

(71) Applicant: TRW AUTOMOTIVE US LLC, Livonia, MI (US)

(72) Inventors: Kevin E. Boyle, Hermitage, TN (US); Mark A. Cartwright, West Lafayette, IN (US); Kevin M. Tilton, Lafayette, IN (US)

(21) Appl. No.: 16/615,263

(22) PCT Filed: May 11, 2018
(86) PCT No.: PCT/US2018/032189

§ 371 Date: Nov. 20, 2019

Related U.S. Application Data
(60) Provisional application No. 62/505,165, filed on May 12, 2017.

(51) Int. Cl. B62D 5/04; B62D 3/12

(52) U.S. Cl. CPC B62D 5/0424; B62D 5/046; B62D 3/12

(57) ABSTRACT

An apparatus for use in turning steerable vehicle wheels includes a first steering member which is linearly movable relative to the vehicle to effect turning movement of the steerable vehicle wheels. A pinion is disposed in meshing engagement with a rack portion of the first steering member. A steering column is connected with the pinion and with a vehicle steering wheel such that rotation of the steering wheel results in linear movement of the first steering member. An electrically powered steering unit is connected to a second steering member extending generally parallel to the first steering member for providing steering assist to the steerable wheels.

### TECHNICAL FIELD

The present invention relates to an apparatus for use in turning steerable vehicle wheels.

### BACKGROUND OF THE INVENTION

A known vehicle steering apparatus includes a steering member which is linearly movable to effect turning movement of steerable vehicle wheels. A pinion is disposed in meshing engagement with a rack portion of the steering member. A steering column interconnects the pinion and a vehicle steering wheel.

In addition, this known steering apparatus includes a ball nut assembly which is connected with an externally threaded portion of the steering member. A motor is connected with the ball nut assembly. The motor is operable to effect rotation of the ball nut assembly relative to the steering member in order to provide steering assist. A steering apparatus having this general construction is disclosed in U.S. Pat. No. 7,055,646.

### SUMMARY OF THE INVENTION

In accordance with the present invention an apparatus for use in turning steerable vehicle wheels includes a first steering member which is linearly movable relative to the vehicle to effect turning movement of the steerable vehicle wheels. A pinion is disposed in meshing engagement with a rack portion of the first steering member. A steering column is connected with the pinion and with a vehicle steering wheel such that rotation of the steering wheel results in linear movement of the first steering member. An electrically powered steering unit is connected to a second steering member extending generally parallel to the first steering member for providing steering assist to the steerable wheels.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a schematic view of an apparatus for use in turning steerable vehicle wheels made in accordance with the present invention; and

FIG. 2 is a cross-sectional view showing a motor connected to a steering member of the apparatus of FIG. 1.

### DESCRIPTION

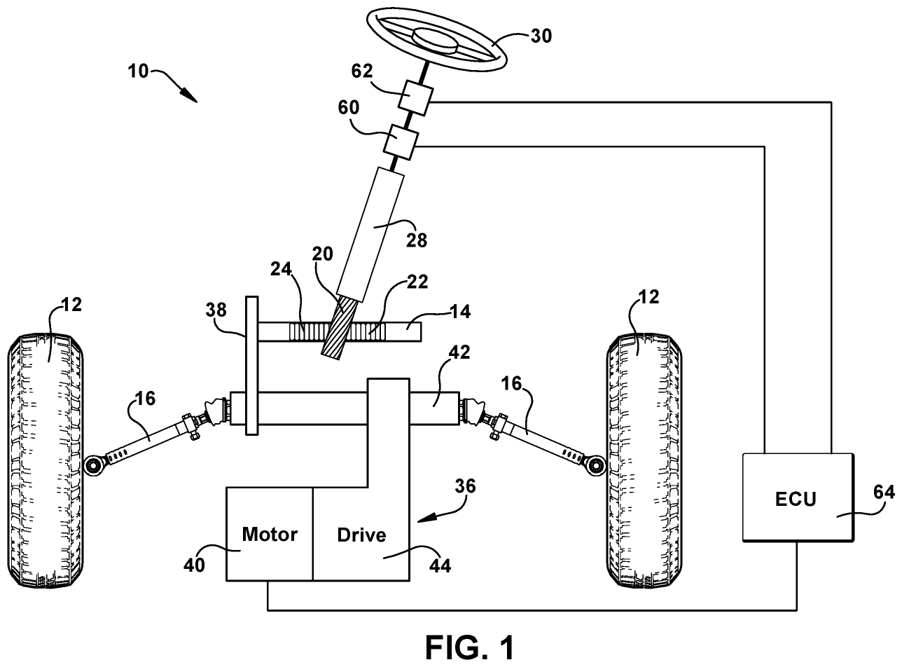

An apparatus 10 for use in turning steerable vehicle wheels 12 is illustrated in FIG. 1. The apparatus 10 includes a first steering member 14 connected to the steerable vehicle wheels 12 by a steering linkage 16. A pinion 20 is in meshing engagement with a rack portion 22 of the first steering member 14 such that rotation of the pinion results in axial or linear movement of the first steering member. In particular, the rack portion 22 includes rack gear teeth 24 disposed in meshing engagement with gear teeth on the pinion 20. The pinion 20 connects to a steering column 28 that includes a rotatable steering wheel 30.

Upon rotation of the steering wheel 30, force is transmitted through the steering column 28 to the pinion 20. The pinion 20 thereby rotates under the influence of force transmitted through the steering column 28. Due to the meshed engagement between the pinion 20 and the rack portion 22, rotation of the steering wheel 30 and, thus, rotation of the pinion results in linear movement of the rack portion of the first steering member 14. Accordingly, rotation of the steering wheel 30 results in turning of the steerable vehicle wheels 12.

An electrically powered steering unit 36 (EPS unit) provides steering assist. A bracket or support member 38 mechanically connects the EPS unit 36 to the first steering member 14. The EPS unit 36 includes a reversible electric motor 40 connected to a second steering member 42 extending generally parallel to the first steering member 14. The bracket 38 interconnects the first and second steering members 14, 42. The EPS unit 36 is operated to affect axial or linear movement of the second steering member 42 to assist linear movement of the rack portion 22 of the first steering member 14. More specifically, the EPS unit 36 includes the electric motor 40 coupled to a drive mechanism 44 which is mechanically connected to the second steering member 42 for effecting linear movement of the second steering member by applying an axial force to the second steering member.

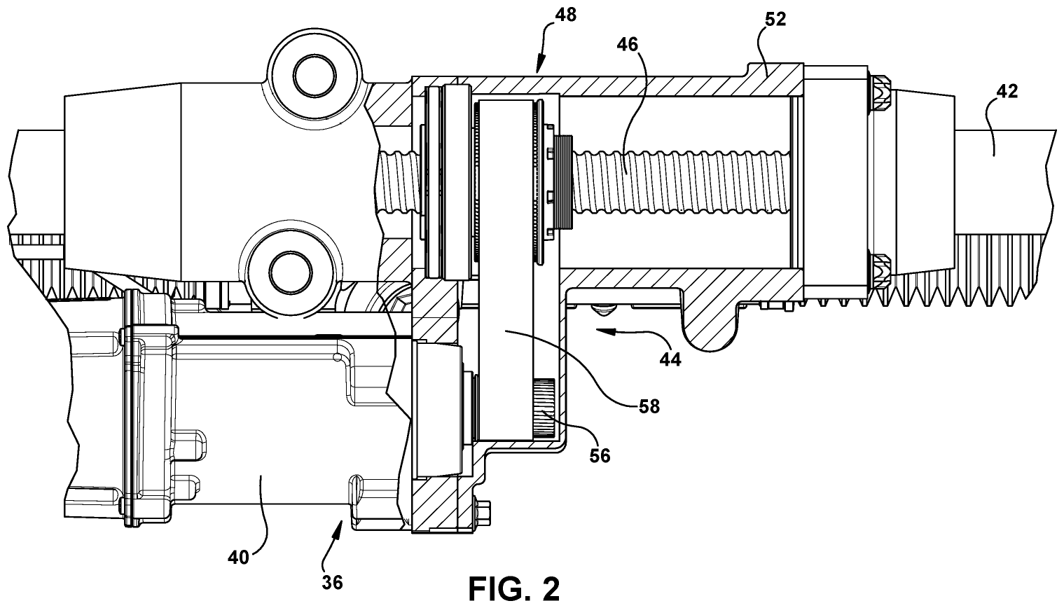

The EPS unit 36 is mechanically coupled to the second steering member 42 by the drive mechanism 44. The steering member 42 has an externally threaded portion 46 (FIG. 2). A ball nut assembly 48 extends around the externally threaded portion 46 and has a plurality of balls (not shown) which are disposed in engagement with the externally threaded portion. The ball nut assembly 48 is rotatable about a longitudinally extending central axis of the steering member 42. Rotation of a ball nut assembly 48 relative to the steering member 42 is effective to move the steering member axially relative to a housing 52 connected to the vehicle. The housing 52 encloses at least a portion of the steering member 42.

The reversible electric motor 40 is operable to rotate the ball nut assembly 48 relative to the steering member 42. The electric motor 40 has an output shaft 56 extending generally parallel to the second steering member 42 and connected to a drive pulley. The drive pulley is connected with the ball nut assembly 48 by a drive belt 58. The drive belt 58 transmits force to the ball nut assembly 48 to rotate the ball nut assembly about the central axis of the steering member 42 during operation of the motor 40. The EPS unit 36 may have the same construction as is disclosed in U.S. Pat. Nos. 7,055,646 and 7,909,132, the entirety of which are incorporated herein by reference. The EPS unit 36 may have any desired construction that transmits rotary motion of the motor 40 to axial or linear motion of the second steering member 42. The EPS unit 36 may be connected to the second steering member 42 by a pulley/belt, planetary gear and/or a ball screw that provide a torque reduction.

The apparatus 10 (FIG. 1) may include two vehicle condition sensors 60, 62 and an electronic control unit 64 (ECU) for controlling the EPS unit 36 based on sensed vehicle conditions. The vehicle condition sensors 60, 62 may include a torque sensor 60 and a position sensor 62 electrically connected to the electronic control unit 64. The torque sensor 60 may sense the torque applied to the steering wheel 30 and generate a signal indicative of the torque. The position sensor 62 may sense the rotational position of the steering wheel 30, and generate an electrical signal indicative of the steering wheel position. The electrical signals from the torque sensor 60 and the position sensor 62 are sent to the ECU 64. The ECU 64 analyzes the output of the sensors 60, 62 and effects operation of the motor 40 of the EPS unit 36 as a function of the output of the sensors. The position sensor 62 may sense the axial position of the first steering member 14 and/or the axial position of the second steering member 42 for use by the ECU 64 in controlling the EPS unit 36. It is also contemplated, that only the torque sensor 60 or only the position sensor 62 may be used to effect operation of the motor 40.

In addition, the ECU 64 may have inputs which vary as a function of sensed lateral acceleration of the vehicle (not shown) or other vehicle operating conditions. In any case, the ECU 64 receives the signals generated by the sensors and actuates the EPS unit 36 in order to apply an axial force to the second steering member 42 to assist in turning of the steerable vehicle wheels 12.

The present invention is advantageous in that the EPS unit 36 provides steering assist to a second steering member 42 extending generally parallel to a rack portion 22 of a first steering member 14. Accordingly, the EPS unit 36 can be sized for a heavily loaded axle.

From the above description of the invention, those skilled in the art will perceive improvements, changes and modifications. Such improvements, changes and modifications within the skill of the art are intended to be covered by the appended claims.

Having described the invention, the following is claimed:

1. An apparatus for use in turning steerable vehicle wheels, the apparatus comprising:
a first steering member which is linearly movable relative to the vehicle to effect turning movement of the steerable vehicle wheels;
a pinion disposed in meshing engagement with a rack portion of the first steering member;
a steering column connected with the pinion and with a vehicle steering wheel such that rotation of the steering wheel results in linear movement of the first steering member; and
an electrically powered steering unit connected to a second steering member extending generally parallel to the first steering member for providing steering assist to the steerable wheels. An apparatus for use in turning steerable vehicle wheels as set forth in claim 1 wherein the first steering member is connected to the second steering member by a bracket.

2. An apparatus for use in turning steerable vehicle wheels as set forth in claim 1 wherein the electrically powered steering unit includes a reversible motor and drive mechanism coupling the motor to the second steering member.

3. An apparatus for use in turning steerable vehicle wheels as set forth in claim 3 wherein the drive mechanism includes a ball nut assembly connected with an externally threaded portion of the second steering member, the motor being operable to effect rotation of the ball nut assembly relative to the second steering member and cause linear movement of the second steering member relative to the vehicle.

4. An apparatus for use in turning steerable vehicle wheels as set forth in claim 1 wherein an output shaft of the motor extends generally parallel to the second steering member.

5. An apparatus for use in turning steerable vehicle wheels as set forth in claim 1 further including at least one vehicle condition sensor and a control unit connected with the at least one vehicle condition sensor, the at least one vehicle condition sensor providing an output to the control unit, the control unit being connected with the motor and being operable to control the operation of the motor as a function of the output from the at least one vehicle condition sensor.

6. An apparatus for use in turning steerable vehicle wheels as set forth in claim 1 further including at least one of a torque sensor for sensing a torque applied to the steering wheel and a position sensor for sensing the position of the steering wheel and a control unit connected with the at least one of the torque sensor and the position sensor, the at least one of the torque sensor and the position sensor providing an output to the control unit, the control unit being connected with the motor and being operable to control the operation of the motor as a function of the output from the at least one of the torque sensor and the position sensor.

7. An apparatus for use in turning steerable vehicle wheels as set forth in claim 7 wherein the at least one of a torque sensor and a position sensor includes a torque sensor and a position sensor, the torque sensor and the position sensor providing outputs to the control unit, the control unit being operable to control the operation of the motor as a function of the outputs from the torque sensor and the position sensor.
